(19) United States
(12) Patent Application Publication
(10) Pub. No.: US 2012/0204469 A1
(43) Pub. Date: Aug. 16, 2012

(54) FISHING ROD SUPPORT SYSTEM

(76) Inventors: James M. Kowalski, Glen Lyon, PA (US); Kenneth Mieczkowski, Sweet Valley, PA (US)

(21) Appl. No.: 13/371,356

(22) Filed: Feb. 10, 2012

Related U.S. Application Data
(60) Provisional application No. 61/441,515, filed on Feb. 10, 2011.

(51) Int. Cl. A01K 97/10; A01K 97/00

(52) U.S. Cl. 43/17.5; 43/21.2

(57) ABSTRACT

A novel fishing rod support system including a fishing rod holder for supporting a fishing rod, an adaptor for suspending a fishing rod in the air and a stand capable of supporting holder on top of a surface. The invention is further directed to a method for using the fishing rod support system and displaying fishing rod holders.

This application is a non-provisional of and claims benefit of priority to U.S. Provisional Application No. 61/441,515, filed Feb. 10, 2011, the entire disclosure of which is hereby incorporated by reference as if set forth fully herein.

### BACKGROUND OF THE INVENTION

1. Field of the Invention

The present invention is directed to a novel system for supporting a fishing rod. In particular, the invention is directed to a fishing rod holder, a stand coupled to the fishing rod holder, and an adaptor for securing and positioning a fishing rod relative to the fishing rod holder and stand.

2. Description of the Related Technology

There exists a wide variety of holders and stands for supporting fishing rods. Some devices, such as that taught by U.S. Pat. No. 5,488,798, have a stake that is driven into the ground and an upwardly extending support surface against which a fishing rod may rest at an inclined angle. These devices, however, are incapable of supporting a fishing rod on hard and generally impenetrable surfaces, such the deck of a boat or pier. Furthermore, these devices do not effectively secure a fishing rod so as to substantially prevent it from sliding relative to the support surface and also cannot be used to suspend a fishing rod in the air.

Other devices, such as the Cabela's Tripod Rod Holder™ and the apparatus of U.S. Pat. No. 4,177,595, utilize a tripod stand to suspend a fishing rod above the ground. These stands, however, are integrally formed with a fishing rod holder. Consequently, the fishing rod holder is incapable of being separated from the stand and anchored in the ground. Such fishing rod holders are also not adapted to support a fishing rod in a leaning orientation, wherein one end of the fishing rod contacts and is supported by the ground while an opposite end contacts and is supported by the fishing rod holder such that the fishing rod is positioned in an inclined orientation relative to the ground. Furthermore, the generally large, cumbersome stands of these devices can also be difficult to carry and store.

In view of these deficiencies, there is a need to develop an improved fishing rod support system. Specifically, there is a need to develop a system capable of effectively securing a fishing rod in both a leaning or suspended position while allowing a fishing rod holder to be anchored in the ground and removably coupled to a support stand.

### SUMMARY OF THE INVENTION

In a first aspect of the invention is directed to a fishing rod support system including a holder for supporting a fishing rod and an adaptor removably mounted on a support member of the holder and capable of receiving a fishing rod. The holder includes a stake adapted to be anchored in ground and a support member attached to a distal end of the stake, wherein the support member has two arms inclined relative to one another and adapted to receive and position a fishing rod therebetween.

In a second aspect, the invention is directed to an adaptor for receiving a fishing rod and for mounting the fishing rod on a fishing rod holder. The adaptor has a body including an interior surface defining a first hole positioned through the body for receiving a fishing rod; wherein a slot is formed in an exterior surface of the body and wherein the slot is capable of being coupled to the fishing rod holder; wherein a second hole is positioned through the exterior surface and an interior surface of the body defining the first hole; and an adjustment member adjustably positioned within the second hole to secure the fishing rod in the first hole.

In a third aspect, the invention is directed to a fishing rod support system including a holder for supporting a fishing rod and a stand adapted to stably position the holder on top of a surface. The holder includes a stake adapted to be anchored in ground and removably positioned within the stand and a support member connected to a distal end of the stake, wherein the support member includes two arms inclined relative to one another adapted to receive and position the fishing rod therebetween.

In a fourth aspect, the invention is directed to a fishing rod holder for supporting a fishing rod. The holder includes a stake capable of being anchored in ground; a support member attached to a distal end of the stake for supporting a fishing rod, wherein the support member includes two arms forming a V shaped configuration adapted to receive and position a fishing rod; and two extension members attached to and extending upwards from the two arms such that the angle formed between one of the two arms and one of the adjoining extension members is about 30° to about 90°.

In a fifth aspect, the invention is directed to a method for displaying a plurality of fishing rod holders involving the step of placing a plurality of the fishing rod holders of the present invention in a clear container.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows a perspective view of an exemplary fishing rod support system including a fully extended holder coupled to an adaptor ring and a fully extended stand.

FIG. 2 shows a front view of an exemplary telescopically extended holder.

FIG. 3 shows the holder of FIG. 2 in a retracted position.

FIG. 4 shows a front view of another holder embodiment.

FIG. 5(a) shows a perspective view of an exemplary adaptor.

FIG. 5(b) shows another perspective view the adaptor of FIG. 5(a).

FIG. 5(c) shows a cross-section of the adaptor of FIG. 5(b) at lines 5C-5C.

FIG. 6(a) shows a perspective view of another adaptor embodiment.

FIG. 6(b) shows a cross-section of the adaptor of FIG. 6(a) at lines 6B-6B.

FIG. 6(c) shows a perspective view of another adaptor embodiment.

FIG. 6(d) shows a cross-section of the adaptor of FIG. 6(c) at lines 6D-6D.

FIG. 7 shows a perspective view of the adaptor of FIG. 5(a) mounted on a holder and receiving a handle of a fishing rod.

FIG. 8 shows a perspective view of an exemplary stand.

FIG. 9 shows a perspective view of another stand embodiment.

FIG. 10 shows a perspective view of a retracted holder coupled to an adaptor and partially retracted stand of FIG. 8.

FIG. 11 shows a perspective view of a retracted holder coupled to an adaptor and fully retracted stand of FIG. 8.

FIG. 12 shows a perspective view of a clear container displaying a plurality of holders extended to different heights.

FIG. 13 shows a perspective view of a fishing rod leaning against and supported by the fishing rod holder of FIG. 2.

### DETAILED DESCRIPTION OF THE PREFERRED EMBODIMENT(S)

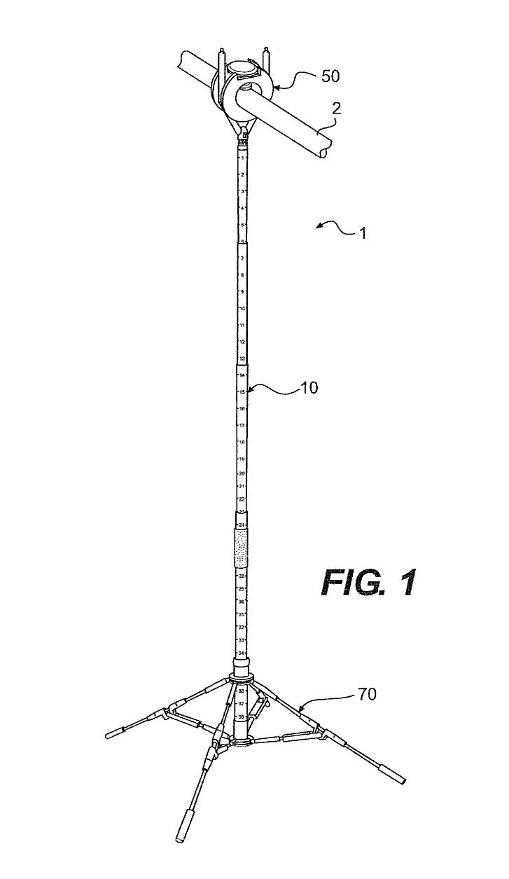

The present invention is directed to a novel fishing rod support system, a method for using the system to support a fishing rod and a method for displaying a plurality of fishing rod holders. The invention is predicated upon the importance of devising a system: capable of being anchored in a penetrable surface, such as the ground; capable of being stably supported and positioned on surfaces unsuitable for staking, such as hard or impenetrable surfaces; capable supporting a fishing rod in a leaning orientation; and capable of suspending a fishing rod above the ground. Referring now to the drawings, wherein like reference numerals designate corresponding structures throughout the views, and referring in particular to the exemplary embodiment of FIG. 1, fishing rod support system 1 includes one or more of a holder 10 for supporting a fishing rod 2, an adaptor 50 that secures fishing rod 2 to holder 10, a stand 70 capable of supporting holder 10 on top of a surface and combinations thereof. Holder 10 may be used independently to support fishing rod 2 in a leaning orientation. Alternatively, two or more components of fishing rod support system 1 may be selectively assembled in order to position fishing rod 2 in alternative orientations and/or support fishing rod 2 in different environments and over varying types of terrain. Preferably, system 1 has a modular, compact, and light weight design that facilitates storage and allows for easy transport. In an exemplary embodiment, the fishing rod support system may further include lights 44, reflectors 46, glow in the dark components or combinations thereof to assist in locating fishing rod 2 and one or more components of fishing rod support system 1, such as holder 10 in the dark.

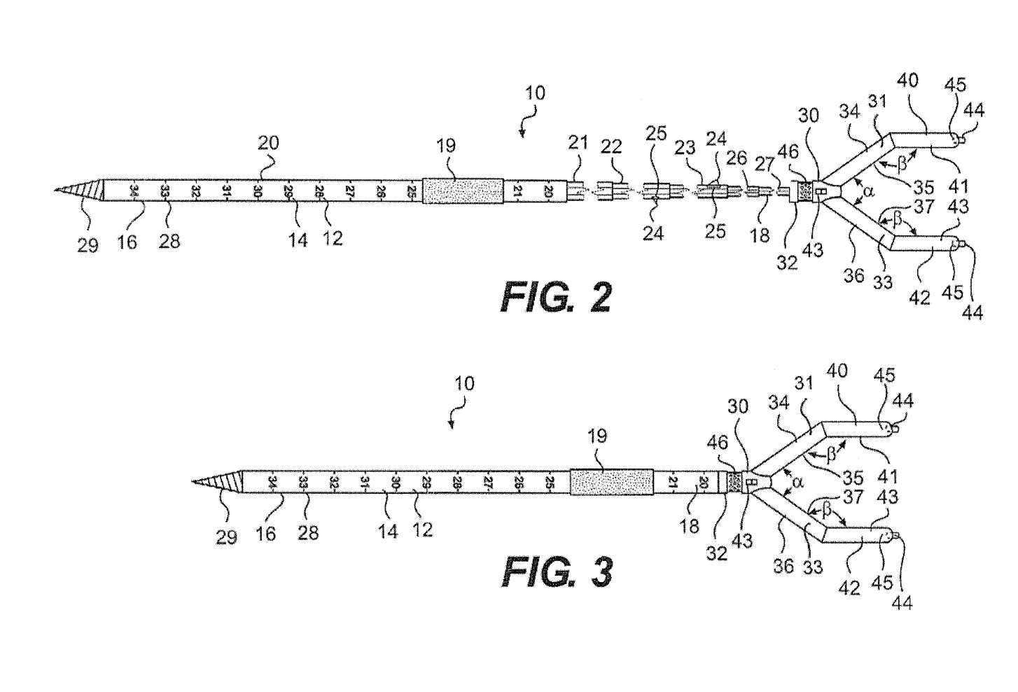

As best shown in FIGS. 2-3, holder 10 of the present invention comprises a stake 12 having an elongated body 14 including a proximal end 16 adapted to be driven into the ground and a distal end 18 connected to a support member 30. Stake 12 may have any suitable structure, configuration and size adapted to be anchored in the ground and removably attached to stand 70. In one embodiment, body 14 may be configured as an elongated rod having a substantially circular or rectangular cross-section. Preferably, stake 12 may have a length of about 10 inches to about 72 inches, preferably, about 10 inches to about 60 inches, more preferably, about 10 inches to about 40 inches and most preferably, about 11.75 inches to about 30 inches or alternatively 16 inches to about 40 inches. Body 14 may have a substantially uniform thickness along its length. Alternatively, body 14 may be tapered, such that a proximal end 16 of body 14 has a smaller cross-sectional area than a distal end 18 to facilitate insertion of stake 12 in the ground. Alternatively, proximal end 16 may have a larger cross-sectional area than distal end 18. Preferably, stake 12 may have a thickness of about 0.25 inches to about 1 inch, preferably, about 0.25 inches to about 0.75 inches, more preferably, about 0.25 inches to about 0.5 inches.

As shown in FIG. 2, stake 12 preferably has a body 14 having a telescoping structure constructed from a plurality of rods 20, 21, 22, 23, 26, 27 that enable body 14 to be extended or retracted to a plurality of different lengths. A plurality of fasteners and corresponding mating features positioned along body 14 secure rods 20, 21, 22, 23, 26, 27 in a retracted, partially extended or fully extended position. Exemplary fasteners may include latches, hooks or other protrusions adapted to be interlocked within a corresponding mating feature, such as a notch or hole. In the embodiment shown in FIG. 2, a fastener located on an exterior surface of rod 23 is configured as a latch 24 that is retractably coupled to a correspondingly sized hole 25 of an adjacent rod 22. When latch 24 is aligned with and extends through hole 25, the two adjacent rods 23, 22 are locked in an extended position relative to one another. Upon depressing latch 24 so as to retract latch 24 relative to hole 25, rod 23 may be retracted within the hollow body of adjacent rod 22. With the exception of proximal most rod 20 forming a staking end of body 14 and distal most rod 27 connected to support member 30 which each has only a fastener or corresponding mating feature, each of rods 21, 22, 23 and 26 has a fastener and mating feature to enable the extension and retraction of body 14. Two or more adjacent rods 20, 21, 22, 23, 26, 27 may be selectively arranged in an extended or retracted position relative to one another enabling body 14 to achieve a plurality of different lengths.

Optionally, one or more hand grips 19 may be positioned along a portion of body 14 to assist a user in inserting stake 12 into the ground or extending and retracting telescopic body 14. Hand grip 19 may be any textured and/or contoured region of body 14 adapted to prevent a user's hand from inadvertently sliding along body 14. In one embodiment, hand grip 19 may be a non-skid surface having a coefficient of friction that prevents the user's hand from slipping, such as a textured tape, sandpaper surface or elastic overmold. Preferably, hand grip 19 is circumferentially wrapped around or positioned along a length of a body portion of stake 12. Hand grip 19 may be inset relative to or protrude out from an exterior surface of body 14. In another embodiment, hand grip 19 may be an indentation in body 14 adapted to conform to the shape and/or relative position of a user's fingers or hand, such as a finger shaped indentation or a cylindrical indication around body 14 having a length corresponding to a user's finger tip. Preferably, hand grip 19 is located proximate to distal and/or proximal ends 18, 16 of stake 12, such as along a portion of proximal most rod 20. Hand grip 19 may also be arranged on one or more of or on each of movable rods 21, 22, 23, 26, 27. When positioned on movable rods 21, 22, 23, 26, 27, hand grip 19 is configured and positioned so as not to interfere with the telescopic ability of body 14.

Body 14 may optionally further include a plurality of indicators 28 representing distance measurements in one or more desired units of measure, such as inches or centimeters. Indicators 28 may be carved into, embossed onto or otherwise positioned along any portion of body 14, including rods 20, 21, 22, 23, 26, 27 to assist a user in determining the depth to which stake 12 is inserted in the ground or the length to which telescopic body 14 is extended. In one embodiment, indicators 28 are scaled markings constructed from a reflective material, such as reflector tape, or glow in the dark material that is adhered to an exterior surface of body 14 to enhance visualization. Alternatively, indicators 28 may be configured as holes penetrating through body 14 such that when a light is illuminated within hollow body 14, indicators 28 may be visible in the dark.

Located on a proximal end 16 of body 14 is a tip 29 adapted to be driven into the ground. To facilitate insertion within the ground, tip 29 may have a substantially tapered configuration, preferably a pyramidal shape, conical shape or arrow shape. Tip 29 may further include a plurality of helical threads circumferentially located on an exterior surface thereof and adapted to further facilitate insertion of stake 12 into the ground and enhance the anchoring force.

Holder 10 further includes a support member 30 located on a distal end 16 of stake 12 and having support structures adapted for supporting a fishing rod in a plurality of different orientations. Exemplary support structures, discussed below, may include one or more of first and second arms 32, 34 and first and second extension members 40, 42. Preferably, the support member 30 enables a user to position fishing rod 2 in a leaning orientation wherein a proximal end of the fishing rod proximate to the reel is positioned against and inclined relative to the ground while a distal end of the fishing rod proximate to the cast fishing line is supported by support member 30. Support member 30 may have any suitable structure, configuration and size for securely retaining a distal end of one or more fishing rods 2. Preferably, support member 30 is adapted to support and position one or more fishing rods 2 in various directional orientations.

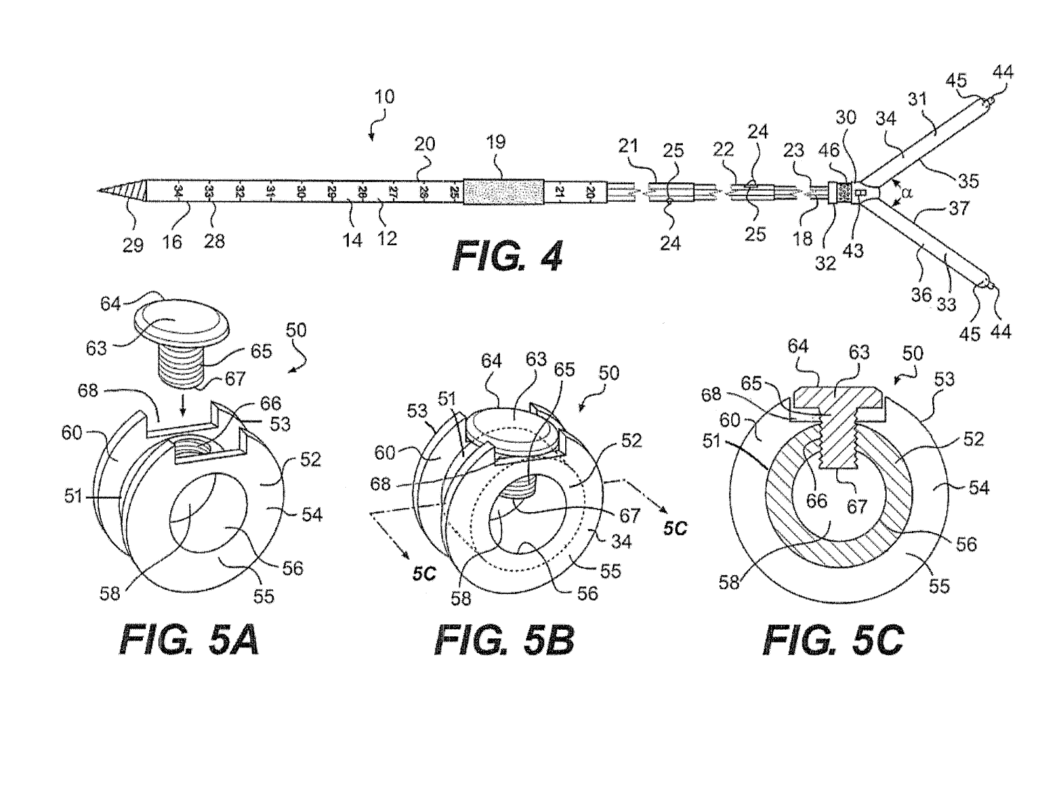

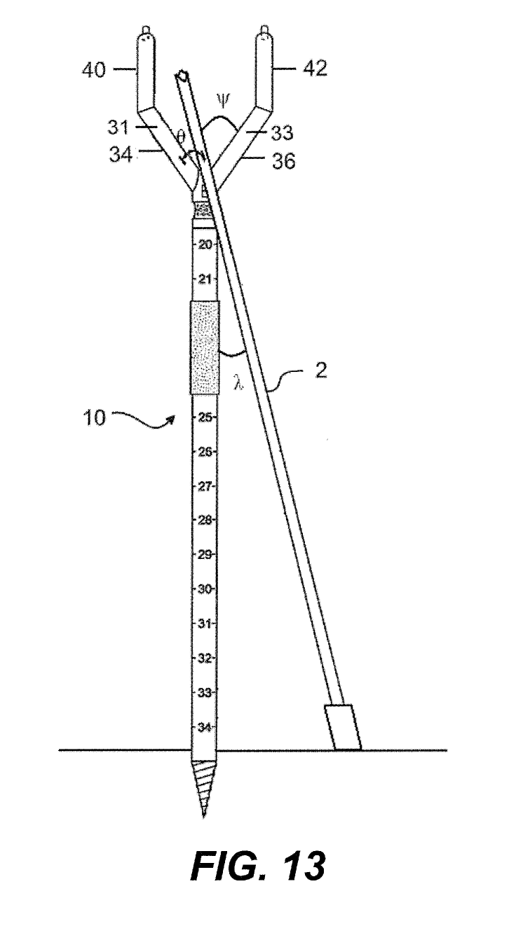

In the exemplary embodiments shown in FIGS. 2-4 and 13, support member 30 includes a cap 32 connected to and centrally positioned between two arms 34, 36, which are angularly offset relative to one another and adapted to securely position fishing rod 2. First and second arms 34, 36 may be connected to opposing sides of cap 32, wherein first arm 34 is attached to cap 32 at a location situated approximately 180° relative to the location where second arm 36 is attached to cap 32. Furthermore, first and second arms 34, 36 may be arranged relative to cap 32 to form a substantial Y shaped configuration, wherein first and second arms 34, 36 form a substantial V shaped configuration. The angle formed between interior surfaces 35, 37 of first and second arms 34, 36, α, is preferably sized to conform to a cross-sectional thickness of fishing rod 2, enabling fishing rod 2 to be securely cradled within the space proximal to the region where arms 34, 36 are joined to cap 32 and/or one another. In an exemplary embodiment, the angle α, as shown in FIGS. 2-4, formed between interior surface 35, 37 is about 30° to about 90°, preferably, about 30° to about 80°, more preferably, about 45° to about 75° and most preferably, about 45° to about 70°. Additionally, arms 34, 36 may have a length adapted to retain a distal end of fishing rod 2 within the space between arms 34, 36. First and second arms 34, 36 may have a length of about 1 inch to about 5 inches, preferably, about 1 inch to about 3 inches, more preferably, about 1.5 inch to about 3 inches and most preferably, about 1.5 inch to about 2 inches. Fishing rod 2 may be positioned between and angularly oriented with respect to the side surfaces 31, 33 adjoining interior surfaces 35, 37 of outwardly extending, angularly offset arms 34, 36 so as to achieve a desired directional orientation, as illustrated by angle θ in FIG. 13. Additionally, by telescopically adjusting stake 12 so as to elevate support member 30 to a desired height, it is possible to further adjust the angular orientation of fishing rod 2 relative to stake 12 and relative to interior surfaces 35, 37 of arms 34, 36, as illustrated by respective angles λ, and ψ in FIG. 13.

In an exemplary embodiment shown in FIGS. 2-3, support member 30 may further include first and second extension members 40, 42 connected to and extending upwards from the distal ends of first and second arms 34, 36. Extension members 40, 42 functions as a guard that further ensures one or more fishing rod 2 is securely retained between arms 34,36 and/or extension members 40, 42 and does not become inadvertently dislodged from support member 30. Specifically, extension members 40, 42 prevent fishing rod 2 from being dislodged from support member 30 when it is exposed to environmental factors, such as high winds and rain or falling debris that may jostle fishing rod 2. In one embodiment, extension members 40 may be positioned relative to first and second arms 34, 36 such that an interior surface 41, 43 of extension members 40, 42 forms an angle β, as illustrated in FIGS. 2-3, relative to an interior surface 35, 37 of first and second arms 34, 36 of about 50° to about 160°, preferably, about 50° to about 155°, more preferably, about 60° to about 150° and most preferably, about 60° to about 140°. Preferably, extension members 40, 42 are oriented so as to be parallel with respect to one another and with respect to the length of stake 12. Alternatively, extension members 40, 42 may be inclined towards one another. Additionally, extension members 40, 42 may have a length suitable for facilitating the retention of one or more, preferably, a plurality of fishing rods 2 by support member 30. In one embodiment, extension members 40, 42 have a length of 0 about 0.5 inch to about 5 inches, preferably, about 0.5 inch to about 3 inches, more preferably, about 1 inch to about 3 inches and most preferably, about 1 inch to about 2 inches.

As shown in FIG. 2-4, holder 10, including stake 12 or support member 30, may optionally have one or more illumination devices and/or means, such as one or more lights 44, one or more reflectors 46 one or more portions of holder 10 that glows in the dark. These illumination features facilitate the location of holder 10 and fishing rod 2 in the dark. Lights 44 may be positioned within a hollow portion of stake 12 and/or support member 30, so as to emit light from any holes positioned through stake 12 and/or support member 30. Alternatively, light 44 may be attached to a surface of stake 12 or support member 30. In an exemplary embodiment, light 44 is arranged and positioned relative to holder 10 so as to sufficiently illuminate and facilitate the location of holder 10 in the dark but does not generate an amount of light that would alarm or frighten nearby fish. This is preferably accomplished by positioning light 44 only on a distal end of holder 10 spaced apart from the ground, such that light 44 is positioned on a surface of or within a cavity of support member 30.

In one embodiment shown in FIGS. 2-4, a cavity 45 formed in the two distal ends of first and second arms 34, 36 or in the distal end of first and second extension member 40, 42, is sized and adapted to receive two lights 44. An illuminating end of light 44 may be inset, flush with or protrude out of cavity 45. Light 44 may be a self-contained light source, such as a glow stick, that is removably positioned within elongated slot shaped cavities 45. Alternatively, light 44 may be an LED light or incandescent light bulb coupled to socket cavities electrically connected to a portable and/or rechargeable energy source, such as a solar cell or battery contained within holder 10. A switch 43, which may be located on cap 32 and operatively associated with the energy source, can be used to turn lights 44 on and off.

As shown in FIGS. 2-4, one or more reflectors 46 may also be attached to any portion of holder 10 to assist in locating holder 10 and fishing rod 2 in the dark. Reflector 46 may be any reflecting sticker or tape adhered to a surface of holder 10 and preferably circumferentially wrapped around a surface of support member 30 and/or stake 12. Reflector 46 is preferably attached to one or more surfaces of support member 30, including one or more surfaces of cap 42, first arm 34, second arm 36, first extension member 40 and second extension member 42.

In another embodiment, one or more portions of holder 10, including stake 12 and support member 30, may be constructed from materials, such as phosphors, that glow in the dark to facilitate location of holder 10 and fishing rod 2. Preferably, this glow in the dark material may be charged by a natural, renewable energy source, such as the sun. Either the entirety or select portions of holder 10 may be constructed from the glow in the dark material. Preferably at least portions of or the entirety of support members 30 and/or extension members 40, 42 are constructed from this material.

Fishing rod support system 1 further includes an adaptor 50 that is designed to receive a portion of fishing rod 2 and to be removably mounted to support member 30 so as to detachably couple fishing rod 2 to holder 10. Adaptor 50 grips and surrounds a width of fishing rod 2, preferably a portion of the handle of fishing rod 2, so as to suspend fishing rod 2 above the ground. In an exemplary embodiment, adaptor 50 may be configured and adapted to secure the foam handle of a light weight fishing rod, such as that used for ice fishing. Adaptor 50 is further designed to be removably, rapidly and vertically mounted directly on and over support member 30 so as to enable a user to quickly remove an adaptor secured fishing rod 2 from holder 10 when a fish is tugging on the line of fishing rod 2.

Adaptor 50 has a body 52 defined by an exterior surface 54 and an interior surface 56 and having a size, structure and configuration adapted to removably securing fishing rod 2 to support member 30. One or more holes 58 positioned through adaptor body 52 so as to pass through opposing front exterior surface 55 and rear exterior surface 53 of adaptor body 52 may be sized and adapted to receive and surround a portion of one or more fishing rods 2. Additionally, one or more slots 60 formed in and defined by a portion of an exterior surface 54 of adaptor body 52 enables adaptor 50 to be removably mounted on and received by support member 30. One or more slots 60 may be positioned along an outer perimeter of adaptor body 52 and configured to enable adaptor 50 to be directly placed on and over a support structure of support member 30 without requiring any further steps to secure adaptor 50 to support member 30, thus allowing for rapid mounting.

As shown in the exemplary embodiment of FIG. 5(a)-5(c), adaptor 50 preferably has a substantially annular, spool shaped adaptor body 52 including a centrally positioned through hole 58 defined and bounded by interior surface 56. Hole 58 may have any suitable configuration adapted for receiving and securing a portion of fishing rod 2. In an exemplary embodiment, interior surface 56 may have a substantially circular, elliptical, triangular, rectangular, pentagonal or hexagonal cross sectional shape, preferably corresponding to the shape of the portion of fishing rod 2 to be received within hole 58. Interior surface 56 preferably has a substantially cylindrical configuration with a diameter of about 0.5 to about 3 inches, preferably, about 0.5 to about 2 inches, and most preferably, about 0.5 to about 1.5 inches. In one embodiment, two or more holes 58 may be formed in adaptor body 52 in order to simultaneously receive and support two or more fishing rods 2.

One or more slots 60 formed in and defined by an exterior surface 54 of adaptor body 52, enables adaptor 50 to be removably mounted on and supported by a support structure of support member 30 so as to enable adaptor 50 to be vertically placed on and over a portion of support member 30. Slot 60 is positioned along and defined in one or more exterior side surfaces 51 of adaptor body 52, adjoining and front and rear exterior surfaces 55, 53. Preferably, the plane bisecting slot 60 or the plane in which the longitudinal axis of slot 60 resides is substantially perpendicular to the longitudinal axis of hole 58. When mounted to support member 30, the plane bisecting slot 60 also bisects hole 58, support member 30 and stake 12. Slots 60 may be sized and adapted to receive first and second arms 34, 36 and/or first and second extension member 40, 42 of support member 30. In an exemplary embodiment, the width of slot 60 may be about 0.5 inches to about 2 inches, preferably, about 0.5 inch to about 1.5 inches and more preferably, about 0.5 inch to about 1 inches. As shown in the embodiment of FIGS. 5(a)-5(c), slot 60 is configured as a continuous, cylindrical channel or groove positioned along the circumferential perimeter of the exterior side surface 51 of adaptor body 52 that enables adaptor 50 to be rotatably positioned on support member 30. By virtue of the added weight of fishing rod 2 and/or the secure fit between adaptor 50 and support member 30, adaptor 50 may be substantially stably positioned so as to resist rotation when coupled to fishing rod 2 and mounted on support member 30. A user may, however, adjust the rotational orientation of adaptor 50 upon applying a sufficient amount of force that would overcome the resisting frictional force between adaptor 50 and support member 30.

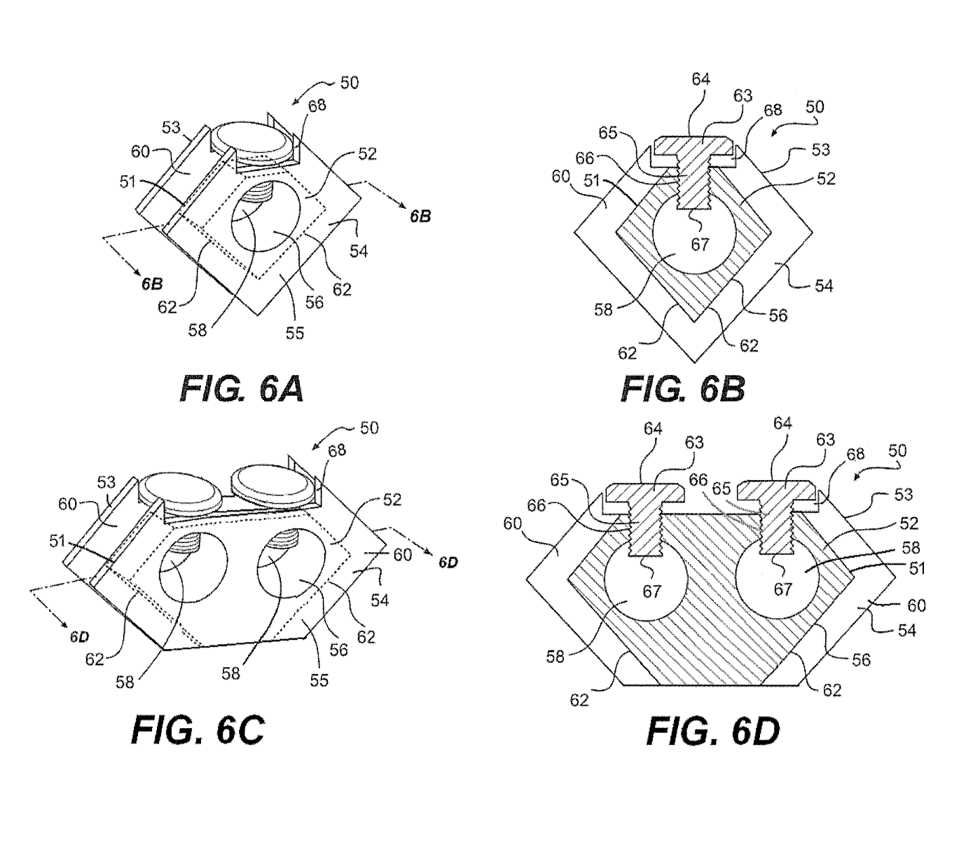

In an alternative embodiment shown in FIGS. 6(a)-6(b), slot 60 substantially conforms to the shape, size and positional orientation of first and second arms 34, 36 so as to rotationally fix adaptor 50 relative to support member 30. Slot 60 may also or alternatively conform to the shape, size and positional orientation of first and second extension members 40, 42. In this embodiment, an exterior side surface 51 of adaptor body 52 has two substantially inclined surfaces 62 forming slot 60. Inclined surfaces 62 preferably form a V shaped configuration and a V shaped slot that conforms to first and second arms 34, 36. Inclined surfaces 62 may be planar or curved so as to conform to the contours of support member 30. In one embodiment, V shaped inclined surfaces 62 may be part of a diamond, as shown in FIGS. 6(a)-6(b), triangle, pentagonal or hexagonal shaped slot 60 configured as a continuous channel located around the perimeter of the exterior side surface 51 of adaptor body 52. Interior surface 56 may have a corresponding or different geometric configuration than the continuous channel formed by slot 60. Preferably, interior surface 56 has a substantially cylindrical configuration for receiving and securing a handle of fishing rod 2.

Alternatively, slot 60 need not be configured as a continuous channel encircling the perimeter of adaptor 50. In the embodiment shown in FIGS. 6(b)-6(c), adaptor 50 can have a substantially solid annular adaptor body 52 including two slots 60 formed in and defined by opposing exterior side surface 51 of adaptor body 52. Furthermore, as shown, adaptor 50 may have at least two holes 58 for simultaneously securing and positioning multiple fishing rods 2 in a single adaptor 50. In this embodiment, slots 60 are spaced apart and separate from one another. As discussed above, slots 60 may substantially conform to the shape, size and positional orientation of first and second arms 34, 36 and/or first and second extension members 40, 42 so as to rotationally fix adaptor 50 relative to support member 30. Preferably, slots 60 may be positioned in the same plane and may be angularly inclined relative to one another in a manner corresponding to the location and position of first and second arms 34, 36 and/or first and second extension members 40, 42. In one embodiment, adaptor 50 may have two or more separate, opposing slots 60 having a configuration conforming to the portion of support member 30 where first arm 34 is joined to extension member 40 and where second arm 36 is joined to second extension members 42. In another embodiment, at least a portion of two slots 60 formed in opposing exterior side surfaces 51 of adaptor body 52 may be inclined towards one another and have an inclined surface 62 forming a V like configuration. In one embodiment, slot 60 may be configured as a single V shaped slot located at a lower region of adaptor body 52.

Adaptor 50 may further include an adjustment member 64 adapted to secure a portion of fishing rod 2 within hole 58. Adjustment member 64 is preferably configured as a fastener that is removably attached to a hole 66 positioned through the interior surface 56 defining hole 58 and an exterior side surface 51 of adaptor body 52, wherein holes 66 and 58 communicate with one another such that the longitudinal axis of hole 66 is substantially perpendicular to the longitudinal axis of hole 58. As shown in the embodiment of FIGS. 5(a)-5(c), adjustment member 64 may be a threaded fastener having a gripping member 63, such as a knob, attached to a threaded body 65 that may be screwed into correspondingly threaded hole 66. To ensure that fishing rod 2 is securely positioned within hole 58, a user may rotate gripping member 63 driving threaded body 65 through hole 66. A distal end 67 of adjustment member 64 consequently is inserted into hole 58 so as to contact, apply pressure to and clamp a portion of fishing rod 2 against an opposing interior surface 56 of adaptor body 52. In one embodiment, distal end 67 may be blunt with a rounded or planar surface that avoids penetrating or otherwise harming the portion of fishing rod 2 received in hole 58. Upon rotating gripping member 63 in an opposite direction, fishing rod 2 may be released from adaptor 50. Preferably, adaptor body 52 may include a second slot 68 defined in and by an exterior side surface 51 of adaptor body 52 that is proximal to and/or communicates with hole 66. Second slot 68 is situated directly above hole 66 and has a longitudinal axis that is perpendicular to the longitudinal axis of hole 66 and parallel to the longitudinal axis of hole 58. Second slot 68 is sized to allow passage of gripping member 63 through an front, rear and side exterior surfaces 55, 53, 51 of adaptor body 52 as adjustment member 64 is screwed into hole 66, allowing for easier access to gripping member 63. As shown in FIG. 5(a)-5(c), second slot 68 may have a substantially rectangular configuration and passes through opposing front and rear exterior surfaces 55, 53 and has a depth that extends from an outer perimeter of exterior surface 54 to a location proximal to a lower surface of slot 60.

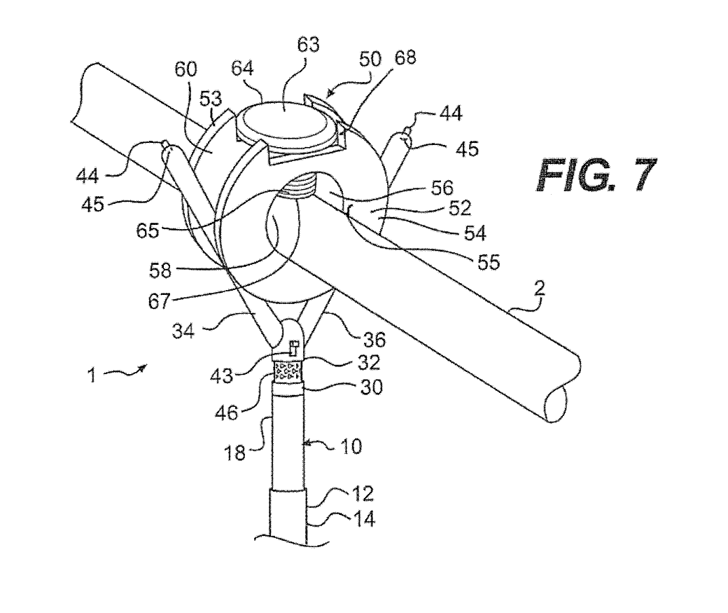

As shown in FIG. 7, when adjustment member 64 is coupled to hole 66, the rotational movement of the adaptor 50 of FIG. 5(a)-5(c) and hence the rotational orientation of fishing rod 2, is restricted to the region over which gripping member 63 abuts first and second arms 34, 36 and/or first and second extension members 40, 42. In one embodiment, gripping member 63 restricts the rotation of adaptor 50 and fishing rod 2 over an angle of about 0° to about 45°, preferably, about 0° to about 30°, more preferably, about 0° to about 25° and most preferably, about 0° to about 15°. In another embodiment, gripping member 63 may be sized so as to abut first and second arms 34, 36 and/or first and second extension members 40, 42, thereby rotationally fixing adaptor 50 and fishing rod 2 relative to support member 30.

As shown in FIG. 1, fishing rod support system 1 may further include a stand 70 capable of removably receiving stake 12 of holder 10. Stand 70 enables holder 10 to be stably supported on top of a surface. In particular, stand 70 is adapted to stably support holder 10 on surfaces unsuitable for inserting stake 12, such as rocky surfaces or the deck of a boat or pier. In an exemplary embodiment, stand 70 has a compact, portable, light weight configuration capable of being extend and retracted as desired.

Stand 70 includes a barrel 72 adapted to receive a proximal end 16 of stake 12, a deployment member 74 that enables the extension and retraction of a plurality of legs 76, 77, 78, 79 and a plurality of spokes 80, 81, 82, 83 that further facilitate the extension and retraction of legs 76, 77, 78, 79.

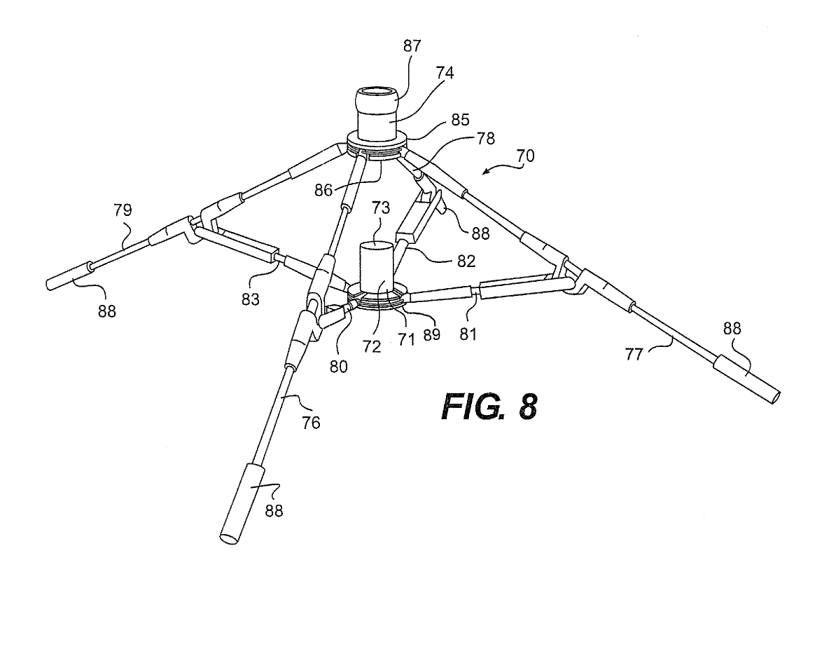

As shown in FIG. 8, barrel 72 has a proximal end 71 and distal end 73 forming a channel adapted for receiving a proximal end 16 of stake 12. Proximal end 16 of stake 12 may be securely friction fitted within the channel of barrel 72 so as to couple holder 10 to stand 70. A proximal end 71 of barrel 72 may also be closed, forming an enclosed cavity for retain proximal end 16 of stake 12.

Barrel 72 is coaxially aligned with deployment member 74. As shown in the embodiment of FIG. 8, deployment member 74 is a tube having a cylindrical channel adapted to receive and to be slidably positioned along a proximal end 16 of stake 12, wherein stake 12 is positioned through deployment member 74 and received within barrel 72. Deployment member 74 may include a flange 85 positioned adjacent to a first end 86 of deployment member 74. In this embodiment, the deployment member 74 is separate and spaced apart from barrel 72. A plurality of legs 76, 77, 78, 79 pivotally attached to flange 85 may be manually, pivotally extended as deployment member 74 is slid towards barrel 72 and retracted as deployment member 74 is drawn away from barrel 72. Legs 76, 77, 78, 79 attached to deployment member 74 are prevented from being overextended when the distal end of barrel 72 abuts and prevents deployment member 74 from sliding over barrel 72. Optionally, deployment member 74 may be selectively locked at various intermediate locations relative to stake 12 using any conventional means, such as friction fitting, latches or notches. Flange 85 may have an abutting surface adapted to conform to a user's finger to facilitate sliding of deployment member 74. A second end 87 of deployment member 74 may also be contoured to facilitate gripping.

Stand 70 may include a plurality of legs 76, 77, 78, 79, preferably at least three or four legs, that stabilize and enable stand 70 to support holder 10. Legs 76, 77, 78, 79 are pivotally attached to flange 85 and spokes 80, 81, 82, 83. In its extended state, legs 76, 77, 78, 79 are splayed and extend out from flange 85 at an inclined angle. When retracted, legs 76, 77, 78, 79 are drawn towards barrel 72 and are substantially parallel with barrel 72. Legs 76, 77, 78, 79 may have a set or adjustable length. In an exemplary embodiment, legs 76, 77, 78, 79 may include a plurality of telescopic adjustable sections, wherein two or more legs may be adjusted to different lengths relative to one another to enable placement of holder 10 on uneven terrain. Optionally, legs 76, 77, 78, 79 further include an integral or removable sheath 88 covering and enlarging the surface area of its proximal end to further enhance the stability of stand 70.

Coupled to legs 76, 77, 78, 79 are a plurality of spokes 80, 81, 82, 83 that assist in extending and retracting the legs. Spokes 80, 81, 82, 83 may be pivotally coupled to a flange 89 of barrel 72 at one end and pivotally coupled to an interior surface of legs 76, 77, 78, 79 at an opposing end. In an exemplary embodiment, spokes 80, 81, 82, 83 are coupled to a central region of legs 76, 77, 78, 79 by a pivoting hinge, wherein a pivot pin located at an end of spokes 80, 81, 82, 83 is positioned through a corresponding aperture of legs 76, 77, 78, 79.

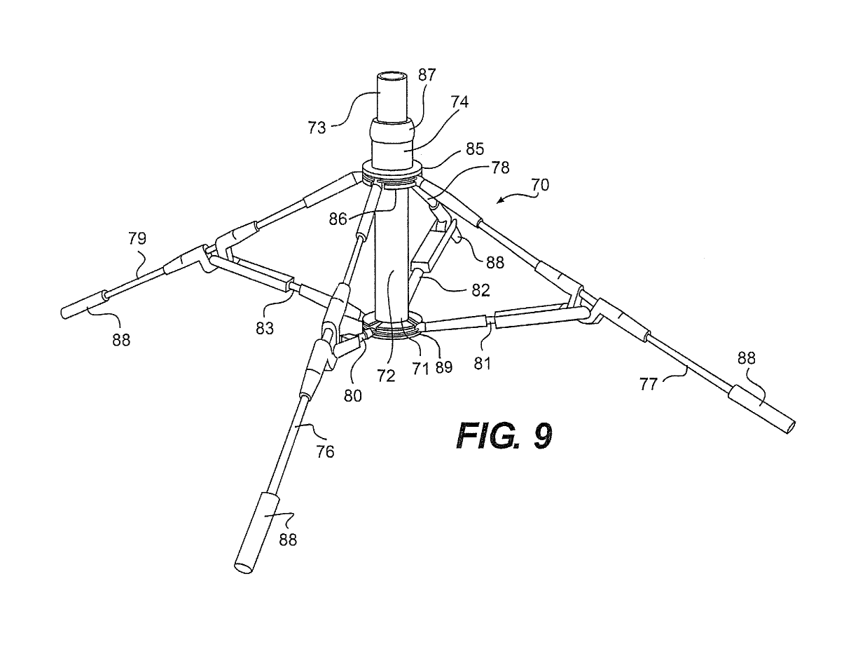

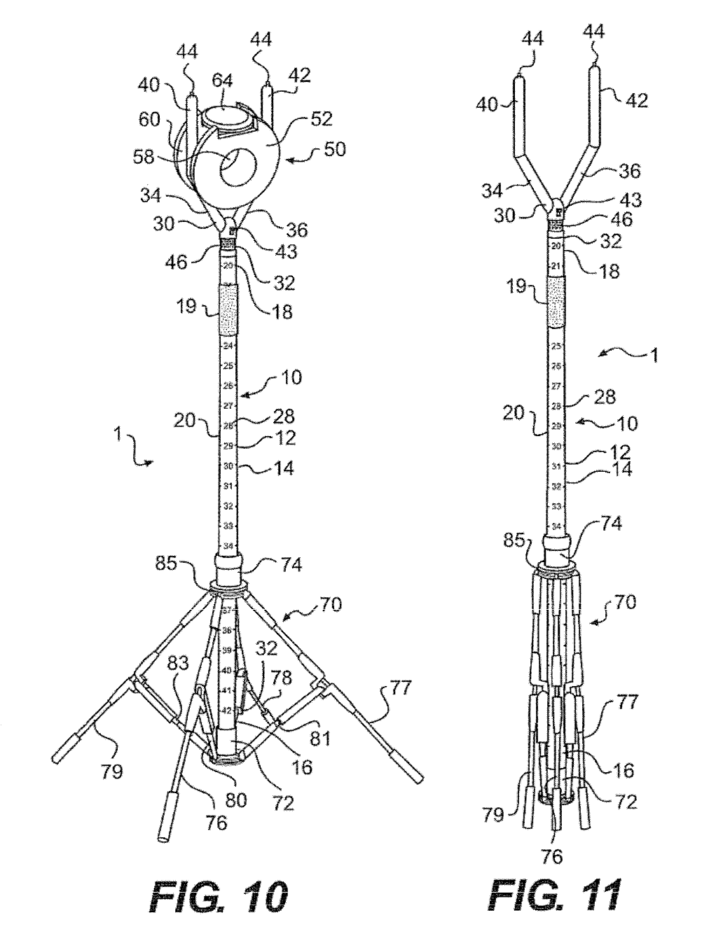

In another embodiment show in FIG. 9, stand 70 may have substantially the same configuration as shown in FIG. 8 with the exception that deployment member 74 surrounds and is slidably positioned over and along an exterior surface of elongated barrel 72. Legs 76, 77, 78, 79 extend as deployment member 74 is pushed towards proximal end 71 of barrel 72 and retracts when it is pulled towards an opposing distal end 73 of barrel 72. In one embodiment, deployment member 74 may be spring biased so as to automatically slide towards a proximal end 71 of barrel 72 upon releasing a latch coupling a portion of deployment member 74 and barrel 72. Deployment member 74 may also be selectively locked at various intermediate locations relative to stake 12 using any conventional means, such as friction fitting, latches or notches. A protruding ledge or stop positioned along an exterior portion of barrel 72, preferably on a proximal end 71 of barrel 72, abuts flange 85 of deployment member 74 to prevent the over extension of legs 76, 77, 78, 79.

Fishing rod support system 1 of the present invention provides a number of advantages over conventional fishing rod holders and stands. Specifically, system 1 has a holder 10 adapted to securely retain and fixedly position one or more fishing rods 2 within support member 30. System 1 may support a fishing rod 2 in a plurality of orientations, wherein fishing rod 2 can be leaned against support member 30, as shown in FIG. 13, in a plurality of different angular positions or suspended above the ground by adaptor 50, as illustrated in FIG. 1. Additionally, system 1 may allow a user to quickly detach an adaptor 50 containing fishing rod 2 from holder 10 by vertically lifting it up from support member 30 without encountering any structural impendence, thereby allowing a user to quickly respond to fish biting on the fishing line. Furthermore, system 1 enables the placement of holder 10 so that it is either anchored in the ground, as shown in FIG. 13, or, with the use of stand 70 as shown in FIG. 1, may be supported on top of a surface, such as the deck of a boat. System 1 is further light weight, compact, modular, retractably positioned to facilitate storage and may have lights and/or reflectors that enable night time fishing and the location of holder 10 and fishing rod 2 in the dark.

The present invention is further directed to a method for using the fishing rod support system 1 of the present invention to support a fishing rod. As shown in FIG. 1, during operation, a user may telescopically extend stake 12 to a desired height for supporting fishing rod 2 and lock stake 12 in the extended position. To precisely determine the adequate length, a user may refer to indicators 28 positioned along body 14 to precisely set stake 12 to a desired height. Prior to or after adjusting the length of stake 12, the user may drive tip 29 and proximal end 16 of stake 12 into a penetrable surface, such as the ground, in order to anchor holder 10 thereto. The user may refer to indicators 28 in order to determine and set the appropriate depth to which holder 10 is anchored in the ground.

A fishing rod may then be placed against support member 30 such that the fishing rod is leaned against support member 30 and positioned at an incline relative to the ground and fishing rod holder 10. A portion of fishing rod 2 is cradled between first and second arms 34, 36. Preferably first and second arms 34, 36 are spaced relative to one another so as to fixedly position fishing rod 2 therebetween, so as to substantially inhibit rolling or any other motion of fishing rod 2. The directional orientation of fishing rod 2 may be adjusted as desired by picking up the handle of fishing rod 2 proximate to the ground and horizontally pivoting fishing rod 2 between first and second arms 34, 36. Two or more or a plurality of fishing rods 2 may be simultaneously positioned and stacked between first and second arms 34, 36 and first and second extension members 40, 42 as desired. By virtue of the structure and position of support member 30, the fishing rods 2 are securely retained within support member 30.

To suspend fishing rod 2 above the ground, the user may insert a portion of fishing rod 2, preferably a handle of fishing rod 2, within hole 58 of adaptor 50. To further secure fishing rod 2 within adaptor 50, a user may rotate a gripping member 63 of adjustment member 64 so that threaded body 65 of adjustment member 64 is driven through hole 66. A distal end 67 of adjustment member 64 thereby contacts, applies force to and clamps fishing rod 2 against an interior surface 56 of adaptor body 52. To mount adaptor 50 and fishing rod 2 on support member 30, adaptor 50 is vertically lowered over and onto one or more support structures of support member 30 such that an interior surface 35, 37 and side surfaces 31, 33 of first and second arms 34, 36 and/or an interior surface 41, 43 and side surfaces first and second extension members 40, 42 are received within one or more slots 60 of adaptor 50. Thus positioned, adaptor 50 secures fishing rod 2 to fishing rod holder 10 and stably suspends fishing rod 2 above the surface of the ground. By virtue of the novel structure and connection between adaptor 50 and holder 10, a user can also rapidly remove fishing rod 2, with adaptor 50 secured thereto, from support member 30 in a single quick vertical motion, lifting the adaptor secured fishing rod from fishing rod holder 10. This unique feature allows a user to quickly respond to and catch fish biting on the fishing line.

When it is desired to rod support holder 10 on a substantially hard surface, such as the deck of a boat, holder 10 may be inserted within and removably coupled to stand 70. Using stand 70 illustrated in FIG. 8, a proximal end 16 of stake 12 may be inserted through deployment member 74 and into barrel 72. Legs 76, 77, 78, 79 of stand 70 may be adjustably extended and retracted as desired by sliding deployment member 74 along the length of the proximal end 16 of stake 12 towards or away from barrel 72, respectively. Using the stand 70 of FIG. 9, proximal end 16 of stake 12 is inserted within barrel 72, and legs 76, 77, 78, 79 may be extended and retracted by sliding deployment member 74 along the length of barrel 72 towards or away from a proximal end of barrel 72, respectively.

After use, fishing rod support system 1 may be compacted for storage. Adaptor 50 may be vertically lifted off of holder 10 to detach slot 60 from support member 30. Rod support holder 10 may be pulled out of and separated from stand 70, and body 14 of stake 12 may be telescopically collapsed. Additionally, legs 76, 77, 78, 79 of stand 70 may be retracted as shown in FIGS. 10-11, whereby legs 76, 77, 78, 79 are drawn together so as to be positioned adjacent to and oriented substantially parallel to barrel 72. System 1 is thus separated into 3 small compact components that may be separately stored.

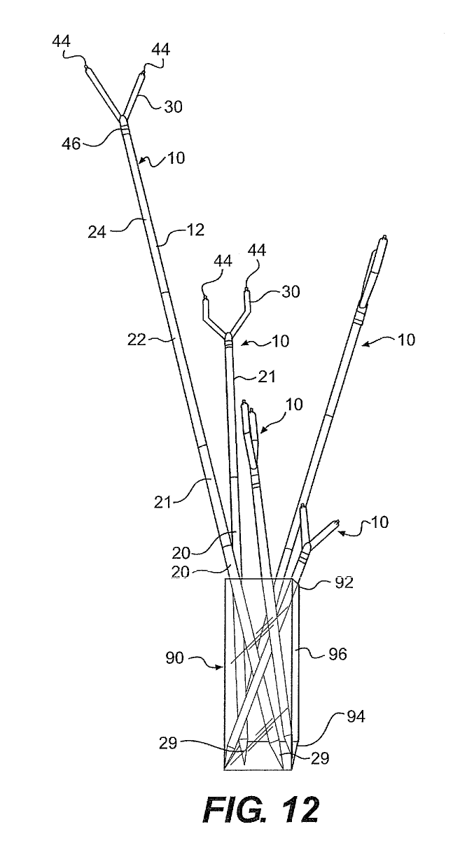

The present invention is also directed to a method for displaying holders 10 of the present invention. As shown in FIG. 12, the method involves arranging one or more holders 10, particularly the holders illustrated in FIGS. 2-4, in an open ended container 90 to enhance the visibility of holders 10, encourage user interaction with holders 10, assist a user in locating and selecting one or more holders 10 and facilitate the marketing, advertisement and sale of holders 10.

Any open ended container 90 capable of retaining a plurality of holders 10 may be used in the display method. Preferably, container 90 is a clear plastic or glass container defined by an enlarged opening 92 spaced apart from a closed bottom end 94 with one or more walls 96 positioned there between. In one embodiment, container 90 may have a tapered configuration with an enlarged opening 92, adapted to securely receive and position a plurality of holders 10, that tapers to a smaller bottom end 94 receiving holder tips 29. Container 90 is preferably sized and adapted to stably and securely retain holders 10 in its telescopically extended and retracted positions.

Container 90 may contain a random selection of a plurality of holders 10. Alternatively, container 90 may contain one or more groups of holders 10 selected according to one or more criteria, such as the color of holder 10, length of holder 10, shape of support member 30, available features of holder 10 or any combination thereof. For example, a user may fill container 90 with a plurality of holders 10 having a uniform size, shape and appearance. Alternatively, a user may fill container 90 with two or more groups of holders 10 having one or more different characteristics.

In one embodiment, support member 30 and tip 28 of each holder 10 may be color coordinated. Container 90 may contain holders 10 having the same coloring. Alternatively, container 90 may contain two or more groups of holders 10, each group having different coloring.

Similarly, container 90 may be filled with holders 10 having the same length or may contain two or more groups of holders 10 having different lengths. Additionally, container 90 may be used to contain a plurality of holders 10 having telescopic stakes 12 extended to the same length. Container 90 may alternatively contain two or more groups of holders 10 that are telescopically extended to different lengths. As shown in FIG. 11, container 90 may include a plurality of holders 10 of different inherent lengths that are also further telescopically extended to different lengths.

Container 90 may also be used to contain a plurality of holders 10 having support members 30 of the same shape. Alternatively, container 90 may be used to contain two or more groups of holders 10 having differently shaped support members 30.

Container 90 may also contain holders 10 having the same or different functional components, such as indicators 28, lights 72, reflectors 46, glow in the dark features, or telescopic stake 12. In one embodiment, container 90 may be placed in a darkened space and may contain a plurality of holders 10 having glow in the dark features or having activated lights 72 on a distal end of their support members 30.

Additionally, these holders 10 may be arranged in container 90 in accordance to a select pattern or in a random orientation. For example, holders 10 may be packed into container 20 such that they are vertically positioned and vertically aligned relative to one another. Alternatively, holders 10 may be inclined relative to an edge or corner of container 90, such that tips 29 of one or more groups of holders 10 may be pointed towards a corner or edge of bottom end 94 of container 90 while the distal end 18 of stake 12 or support member 30 rests against an opposing edge or corner of container opening 92. Holders 10 may also be arranged in container 90 such that they are aligned and face a one or two or more directions within container 90. For example, two groups of holders 10 may be arranged in container 90 such that the holders are oriented in opposing directions, at different angular orientation and/or at opposing diagonal orientations. Preferably, holders 10 are arranged in container 90 such that the edge of container 90 contacts body 14 of holder 10 at a point that is capable of stably retaining holder 10 in its telescopically extended and retracted positions.

Container 90 may be displayed in the area of a store corresponding to the utility of the holders 10 contained therein. For example, holders 10 having glow in the dark features, reflectors 46 or lights 72 may be located in a section of the store dedicated to night fishing.

By virtue of arranging holders 10 in an open ended container 90, as discussed above, users are encouraged to interact with, examine and investigate holders 10. Furthermore, the aforementioned display means enhances the attractiveness of holders 10 and thereby facilitates marketing, advertising and sales of holder 10. This arrangement also assists a user in quickly and effectively locating and selecting an appropriate holder 10 to address their specific needs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A fishing rod support system comprising:
a holder for supporting a fishing rod, wherein the holder comprises:
a stake adapted to be anchored in ground; and
a support member attached to a distal end of the stake, wherein the support member comprises two arms inclined relative to one another and adapted to receive and position the fishing rod therebetween; and
an adaptor removably mounted on the support member and capable of receiving the fishing rod.

2. The system of claim 1, wherein the adaptor further comprises a body and wherein a first hole for receiving the fishing rod is positioned through the body, wherein a first slot is defined in an exterior surface of the body, and wherein a portion of the support member is removably received within the first slot.

3. The system of claim 2, wherein the exterior surface of the body defining the first slot has a width of about 0.5 inches to about 2 inches.

4. The system of claim 2, wherein a portion of the body defining the first hole has a diameter of about 0.5 inches to about 3 inches.

5. The system of claim 2, wherein the body has a spool shape.

6. The system of claim 2, wherein the first slot is a substantially continuous channel formed along an outer perimeter of the body.

7. The system of claim 2, wherein a portion of the exterior surface of the body defining the first slot has a substantially V shaped configuration.

8. The system of claim 2, wherein a second slot is defined within the exterior surface of the body, wherein the first and second slots are spaced apart from one another and wherein the first and second slots are sized and oriented to conform to a support structure of the support member.

9. The system of claim 2, wherein a second hole is positioned through the exterior surface and the interior surface of the body defining the first hole, wherein the adaptor further comprises an adjustment member adjustably positioned within the second hole to secure a portion of the fishing rod in the first hole.

10. The system of claim 9, wherein the adjustment member comprises a gripping member attached to a threaded body.

11. The system of claim 10, wherein the exterior surface of the body further defines a second slot and wherein the gripping member protrudes out from the second slot.

12. The system of claim 1, wherein the holder further comprises two extension members attached to and extending upwards from the two arms.

13. The system of claim 12, wherein an angle formed between one of the two arms and the adjoining extension member is about 30° to about 90°.

14. The system of claim 12, wherein the extension members are parallel to the stake.

15. The system of claim 1, wherein the holder further comprises a reflector or a light attached to a distal end of the support member.

16. The system of claim 1, wherein a portion of the holder is constructed from a material that glows in the dark.

17. An adaptor for receiving a fishing rod and for mounting the fishing rod on a fishing rod holder, wherein the adaptor comprises a body and wherein the body comprises:
an interior surface defining a first hole positioned through the body for receiving the fishing rod;
wherein a first slot is formed in an exterior surface of the body and wherein the first slot is capable of being coupled to the fishing rod holder;
wherein a second hole is positioned through the exterior surface and the interior surface of the body; and
an adjustment member adjustably positioned within the second hole to secure the fishing rod in the first hole.

18. The system of claim 17, wherein the body is spool shaped.

19. The system of claim 17, wherein the first slot is a continuous channel located along an outer perimeter of the body.

20. The system of claim 17, a portion of the exterior surface of the body defining the first slot has a substantially V shaped configuration.

21. The system of claim 17, wherein a second slot is formed in the exterior surface of the body, wherein the first and second slots are spaced apart from one another and adapted for being coupled to the fishing rod holder.

22. The system of claim 17, wherein the adjustment member comprises a gripping member attached to a threaded body.

23. The system of claim 22, wherein a second slot is defined the exterior surface and wherein the gripping member protrudes out from the second slot.

24. A fishing rod holder comprising:
a holder for supporting a fishing rod, wherein the holder comprises:
a stake capable of being anchored in ground; and
a support member attached to a distal end of the stake for supporting the fishing rod, wherein the support member comprises:
two arms forming a V shaped configuration adapted to receive and position the fishing rod; and
two extension members attached to and extending upwards from the two arms such that the angle formed between one of the two arms and the adjoining extension members is about 30° to about 90°.

25. The fishing rod holder of claim 24, wherein the stake comprises a plurality of telescopically adjustable sections.

26. The fishing rod holder of claim 24, wherein the extension members are parallel to the stake.

27. The fishing rod holder claim 24, further comprising a reflector or a light attached to a distal end of the extension members.

28. The fishing rod holder of claim 24, wherein a portion of the holder is constructed from a material that glows in the dark.

29. The fishing rod holder of claim 27, further comprising a light switch operatively associated with the light.

30. A method for displaying a plurality of fishing rod holders comprising the step of placing the plurality of fishing rod holders in a container, wherein at least one of the fishing rod holders comprises:
a stake capable of being anchored in ground; and
a support member attached to a distal end of the stake for supporting the fishing rod, wherein the support member comprises:
two arms forming a V shaped configuration adapted to receive and position the fishing rod; and
two extension members attached to and extending upwards from the two arms such that the angle formed between one of the two arms and the adjoining extension members is about 30° to about 90°.

31. The method of claim 30, wherein at least one of said holders comprises an illumination means and wherein the method further comprises the step of displaying the container in a dark space when the illumination means is activated.
